(19) United States
(12) Patent Application Publication
(10) Pub. No.: US 2006/0038091 A1
(43) Pub. Date: Feb. 23, 2006

(54) Cable tray system

(76) Inventors: Gregg Winn, Belleville, IL (US); Terry McCrary, Pinckneyville, IL (US); Donald Ohms, Sparta, IL (US)

Correspondence Address: R. Blake Johnston;PIPER RUDNICK LLP, P.O. Box 64807, Chicago, IL, 60664-0807, US

(21) Appl. No.: 10/920,465

(22) Filed: Aug. 18, 2004

(51) Int. Cl. F16L 3/00

(52) U.S. Cl. 248/49

(57) ABSTRACT

A cable support system has a support bracket with an elongated member defining a longitudinal central axis. The member also defines at least one slot with its longest dimension transverse to the central axis. At least two adjacent support trays are provided and each have an end secured to the bracket. Each tray end has a wire with a bent hook end where the two hook ends oppose each other at the bracket. The slot engages both hook ends. A fastening mechanism is provided for securing both tray ends to the elongated member.

### TECHNICAL FIELD OF THE INVENTION

The invention relates generally to cable management systems, and more particularly to wire mesh cable support trays that are interconnected at improved support brackets.

### BACKGROUND OF THE INVENTION

Cable tray systems are known for supporting a network of cables below raised floors or above hung ceilings and other areas where cable networks are located. The conventional cable tray system is made of a large number of trays or modules positioned end to end along the desired route where cables are to placed and supported. The cable trays, in turn, are supported by a number of brackets or hangers mounted on posts (sub-floor posts holding up a raised floor or any other columns), walls, ceilings, floors or other building structures. The trays are connected to each other by separate clips or clamps.

As shown in FIG. 1, one conventional design has a support bracket 200 that holds a wire mesh tray 202. A clamp plate 204 with a slot in its center is placed over longitudinal wires 206 of the wire mesh tray 202. A screw 208 is placed through the clamp plate 204 and bracket 200 where it is secured by a nut (not shown) underneath the bracket, which in turn secures the wire mesh tray 202 to the bracket.

Adjacent mesh trays 202 are joined to each other at their abutting longitudinal ends by separate clips (not shown) typically on the sidewalls of the mesh trays of 202 to form one continuous support. This system is inefficient, however, since it requires two separate connections to the trays (one to the bracket for supporting the tray and the other with separate clips attaching the trays to each other).

Other pieces or modules of the cable tray system include solid, flat junction plates (sometimes referred to as “pizza boxes”). These junction plates act as a hub or turning location, and connect to two or more support trays, each extending in a different direction. The junction plate has a number of straight (i.e., in one line) arrays of holes where each array extends in a different direction on the junction plate. Each array used to connect to a support tray can only receive one end of one support tray. The end of the support tray has a row of hooked wires that can be placed in the holes in one of the arrays.

The known junction plates have limited adaptability because they do not provide a way for consecutive wire mesh trays to be placed directly next to each other in all possible directions (for example along the left edge, right edge, upper edge or lower edge in plan view) over the junction plate. In other words, no more than one support tray can engage any single array of holes. Thus, the known junction plate does not provide any way to maintain the continuous end-to-end positioning of the support trays over the junction plate in multiple directions in order to maintain the continuous cable route on the support trays without a break in the route for the junction plate.

These and other objects and advantages will be apparent from the following specification.

### SUMMARY OF THE INVENTION

In the present invention, brackets are provided that both hold wire mesh support trays and provide the connection between adjacent wire mesh trays eliminating the need for separate clips between the wire mesh trays.

In a first aspect of the invention, a cable support system has a support bracket with an elongated member defining a longitudinal central axis. The member also defines at least one slot with its longest dimension transverse to the central axis. At least two adjacent support trays are provided and each have an end secured to the bracket. Each tray end has a wire with a bent hook end where the two hook ends of the two adjacent support trays oppose each other and engage the slot of the member. A fastening mechanism is provided for securing both tray ends to the elongated member.

In another aspect of the invention, the bracket member has an alternating array of apertures and slots along its central axis in order to connect to the fastening mechanism in between the slots provided for the hook ends.

In yet a further aspect of the invention, the feature of using slots extending parallel to the longitudinal wires on the support trays is applied to other support devices such as the junction plates. More specifically, a cable guide system has at least two wire-mesh support trays. Each tray has at least one end with a plurality of wires where the wires have a bent hook end. A junction plate with multiple arrays of elongated slots is provided to receive the hook ends of support trays. The slot arrays are arranged for selectively extending the support tray(s) in two or more different directions from the plate. Since slots are used on the plate, instead of just circular holes, on all or most of the arrays on the plate, two adjacent support trays can be connected end-to-end at any one of the slot arrays. The arrays also have alternating hole arrays to engage a fastening mechanism to secure the trays to the plate.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 is a bracket and clamp of a prior art cable support system;

FIG. 2 front and top perspective view of a cable support system in accordance with the present invention;

FIG. 3A is top a plan view of the cable support system in accordance with the present invention;

FIG. 3B is a top plan view of an alternative configuration of the cable support system in accordance with the present invention;

FIG. 3C is a top plan view of yet another alternative configuration of the cable support system in accordance with the present invention;

FIG. 4A is a top plan view of a wire mesh support tray used in the cable support system in accordance with the present invention;

FIG. 4B is a side elevation view of a wire mesh support tray used in the cable support system in accordance with the present invention;

FIG. 4C is an end elevation view of a wire mesh support tray used in the cable support system in accordance with the present invention;

FIG. 5 is a top plan view of a clamping clip used in the cable support system in accordance with the present invention;

FIG. 6 is a side elevation view of the clamping clip used in the cable support system in accordance with the present invention;

FIG. 7 is a top and front perspective view of a bracket used in the cable support system in accordance with the present invention;

FIG. 8 is a cross sectional side view of the clamping connection on a bracket used in the cable support system in accordance with the present invention;

FIG. 9 is a front elevation view of a clamping connection on a bracket used in the cable support system in accordance with the present invention;

FIG. 10 is a front elevation view of a clamping connection on an alternative portion of the bracket used in the cable support system in accordance with the present invention;

FIG. 11 is a top perspective view of a junction plate used in the cable support system in accordance with the present invention;

FIG. 12 is a top perspective view of the junction plate used in the cable support system in accordance with the present invention; and

FIG. 13 is a side elevation view of the junction plate used in the cable support system in accordance with the present invention.

### DESCRIPTION OF THE PREFERRED EMBODIMENTS

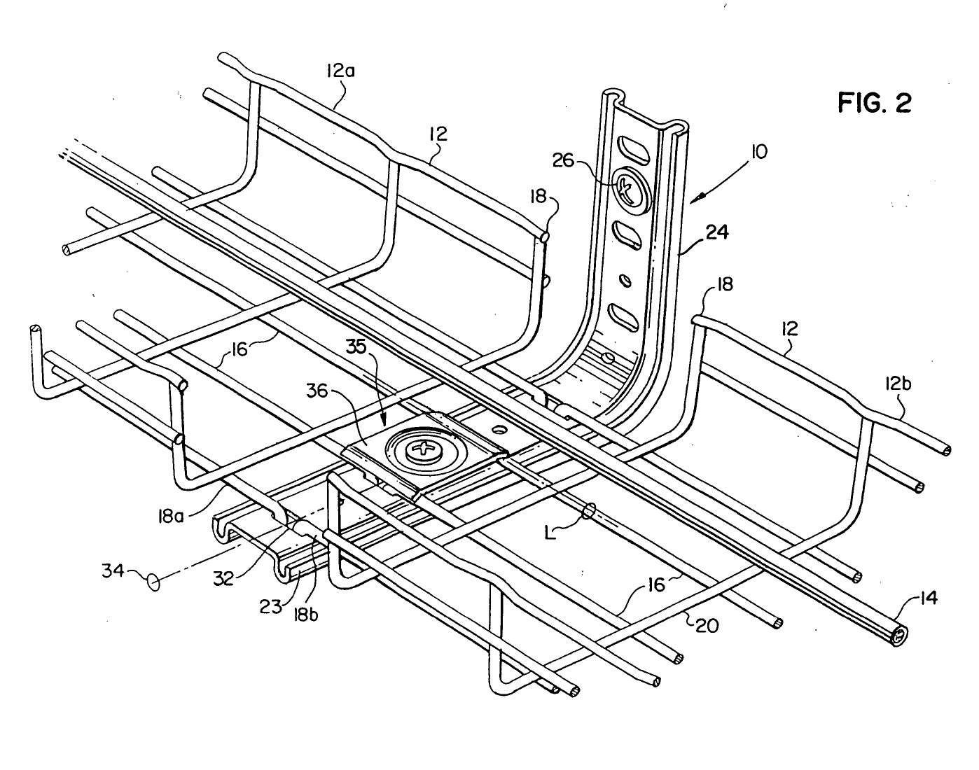

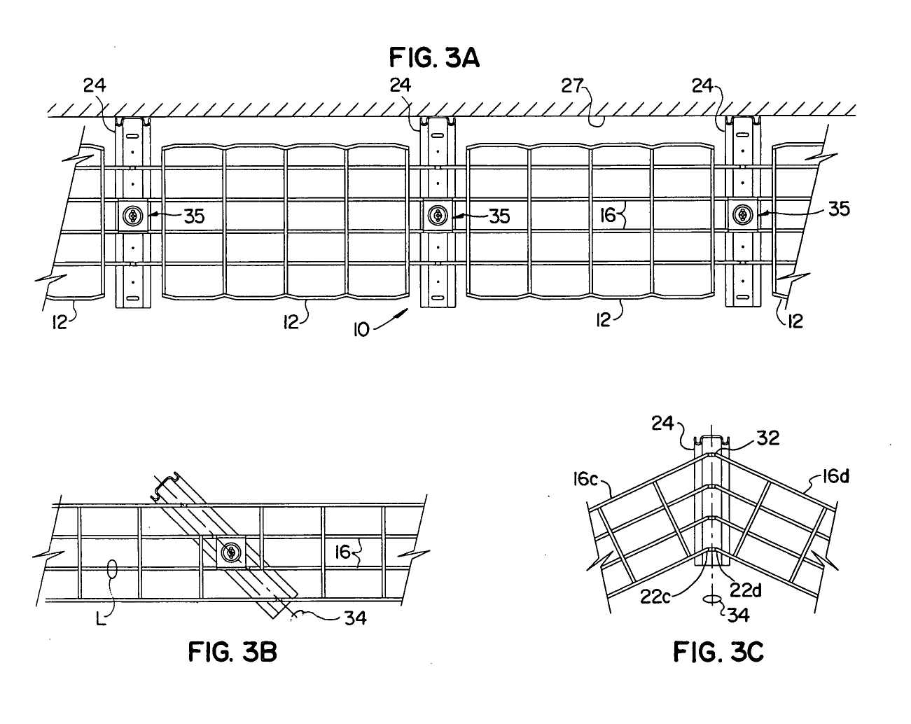

A cable support system, indicated in general at 10 in FIGS. 2 and 3A, is typically used for sub-floor or above-ceiling support of cable networks. The system, however, is not limited to one particular use or position. The cable support system 10 includes a number of support trays 12 placed end-to-end along the paths of a cable or cables 14 that they are to support. As shown in FIG. 3A, in a chain of support trays 12 along the path for a cable 14, a single bracket 24 will support the trays 12 at each joint between adjacent trays. The bracket 24 can also be used at the end of a chain of trays to support a single support tray.

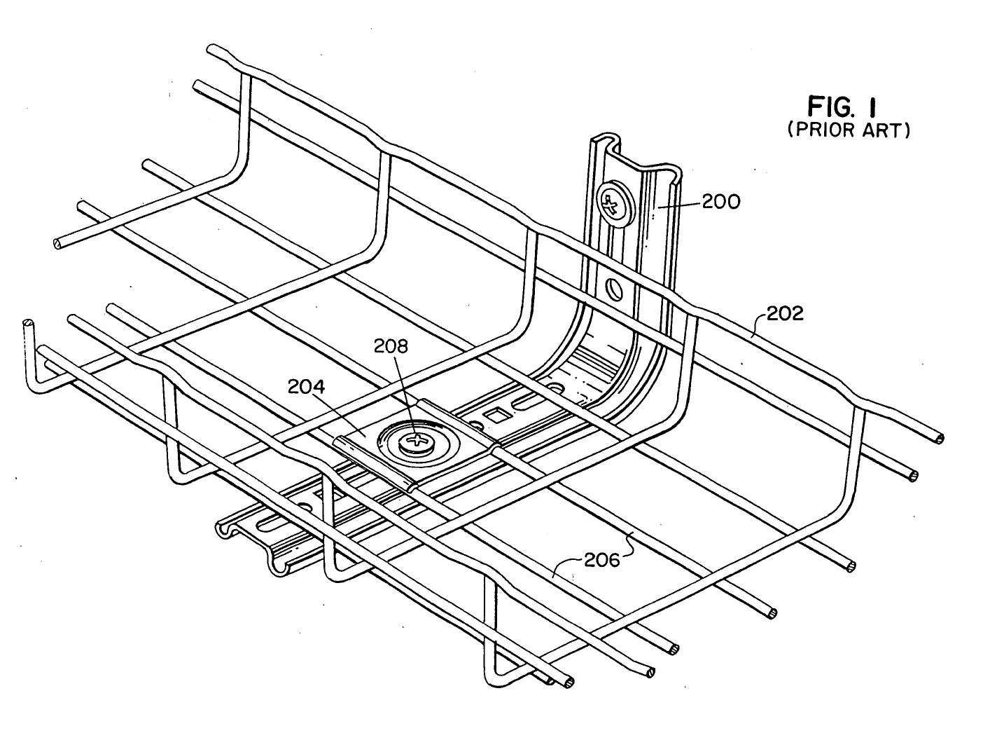

As shown in FIGS. 1-4, the support trays 12 preferably are wire mesh and have longitudinal or main wires 16 that extend from at least one end 18 of each support tray 12. Here, the wire mesh trays also have a number of transverse wires 20 forming the wire mesh.

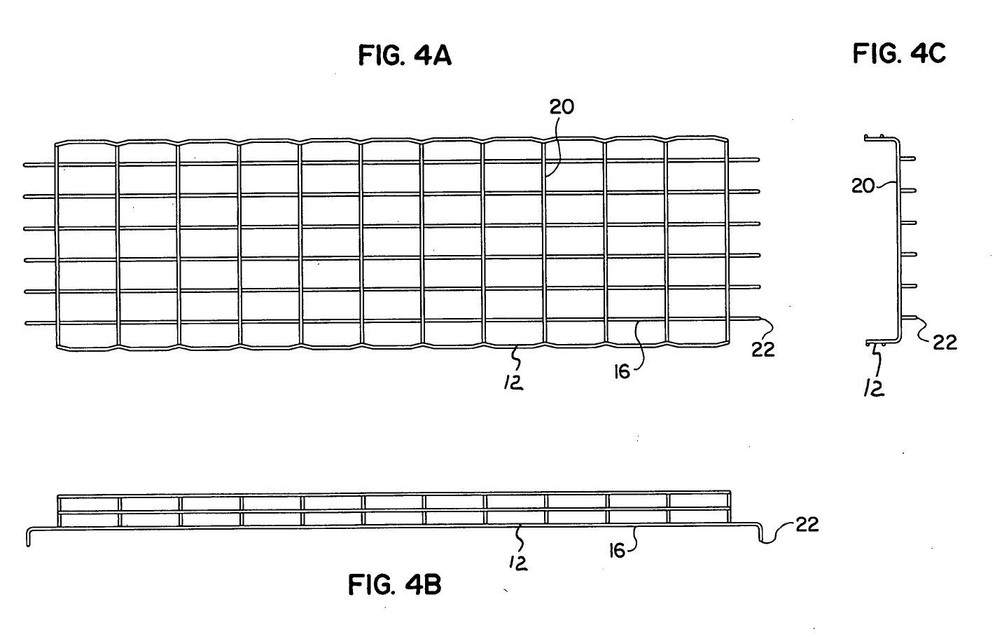

The main wires 16 have bent hook ends 22 (shown in FIGS. 4B and 8-10) for connecting to bracket 24. It will be appreciated that while the hook ends 22 are shown bent straight downward at 90 degrees, the hook ends can have many different configurations including downwardly extending curves, multiple bends, bends at angles other than 90 degrees and even hooks extending upward.

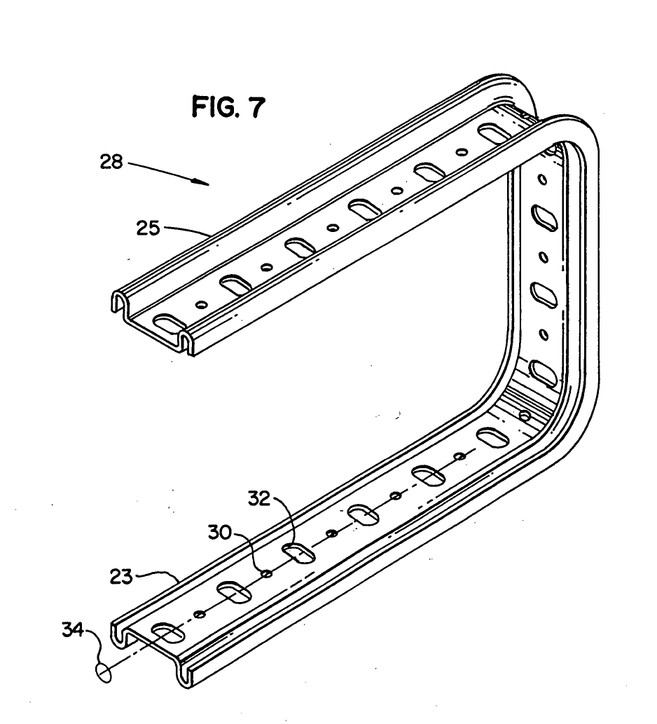

Bracket 24 (shown in FIG. 2) is used to hold the support trays 12 and is secured to walls, posts, other brackets, or any other structure that is strong enough to hold the cable system 10. The bracket 24 has a fastener 26, or any other fastener, for securing the bracket to its supporting structure. Here, an L-shaped bracket 24 or C-shaped bracket 28 (shown in FIG. 7) is used. These brackets 24 or 28 each have an elongated arm or member 23 used for holding the support trays 12. It will be appreciated that any bracket shape can be used as long as it has an elongated member or structure for holding the support trays 12.

As shown in FIG. 7, the elongated member 23 on the bracket 28 (and similarly on bracket 24) has an array of circular holes 30 alternating with an array of elongated slots 32. The slots 32 are elongated in a direction transverse or generally perpendicular to a longitudinal, central axis 34 defined by the bracket member 23.

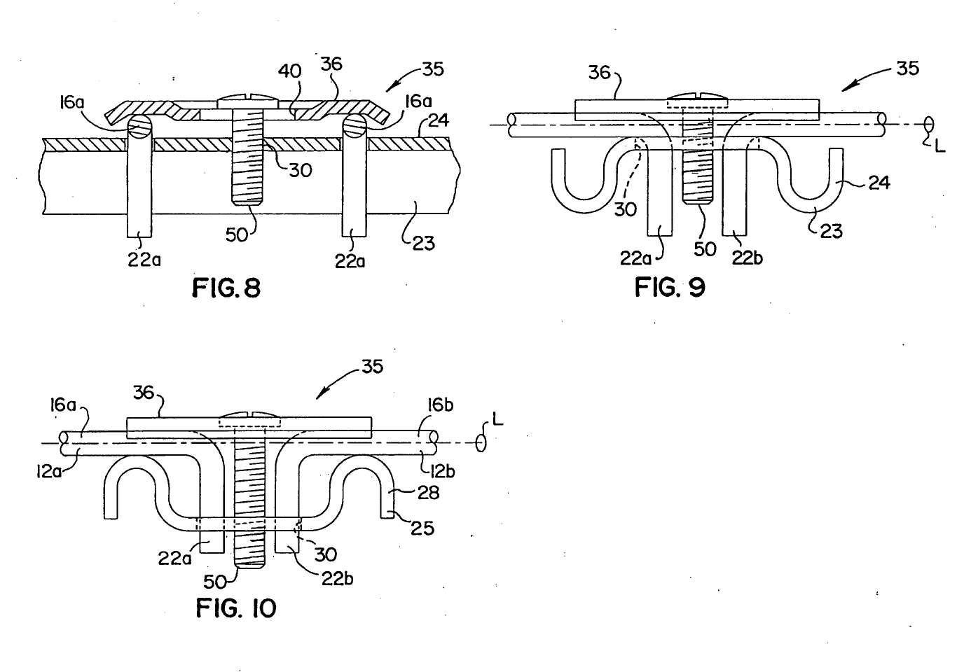

The bracket 24 or 28 holds two opposing longitudinal ends 18 of adjacent support trays 12a and 12b as shown in FIG. 2. In one embodiment, the adjacent support trays 12a and 12b are secured to the bracket 24 so that main wires 16a on one support tray 12a align directly with the main wires 16b on the other adjacent support tray 12b so that the main wires 18a and 18b cooperatively define a single straight line ‘1’ extending over the bracket and perpendicular to longitudinal, central axis 34. The slot 32 is obround but can be rectangular, oval or any other shape that is sufficiently elongate to receive both opposing hook ends 22a and 22b (shown in FIGS. 8-10) from adjacent support trays 12a and 12b to align the main wires 16a and 16b

In other embodiments, the main wires 16a and 16b may be at an angle to axis 34, as shown in FIGS. 3B and 3C. Furthermore, with respect to FIG. 3C, while the hook ends 22c and 22d are symmetrically positioned about axis 34 and within slot 32, the adjacent main wires 16c, 16d leading to the opposing hook ends 22c, 22d do not necessarily form a straight line.

It will also be appreciated that while FIGS. 3A-3C show a single fastening mechanism 35 in the middle of a bracket 24, the fastening mechanism 35 can be placed off center or multiple fastening mechanisms 35 can be used on a number of adjacent, longitudinal wires 16.

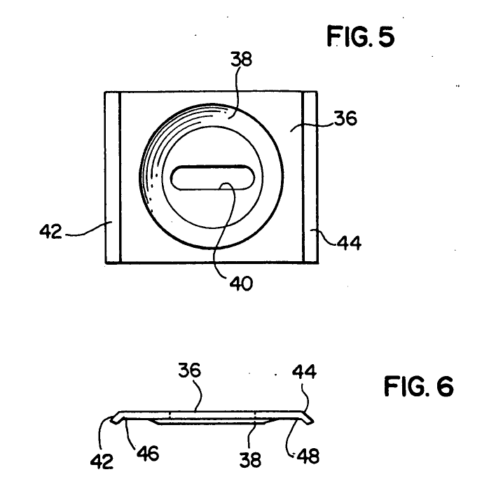

As shown in FIGS. 2, 3A and 8-10, the support system 10 also includes at least one fastening mechanism generally indicated as 35 that is used to secure the support trays 12 to the brackets 24 or 28. As illustrated in FIGS. 5 and 6, the fastening mechanism 35 includes a clamping clip 36 (shown on FIGS. 5-6). The clip 36 has an indented portion 38 that defines a central aperture or slot 40. The clip 36 also has two opposing bent edges 42, 44 forming grooves 46, 48 in order to receive two adjacent, parallel sets of opposing main wires 16a, 16b. The clip 36 is sized so that when the trays 12a and 12b are placed on a bracket 24 and the clip 36 is placed on the wires 16a, 16b, as shown in FIGS. 8-9, the aperture 40 is laterally aligned with one of the holes 30 on the bracket member 23. A fastener 50, such as a threaded screw, is placed through the aperture 40 on the clip 36 and engages the hole 30 on the bracket member 23.

It will be appreciated that the trays 12 can be clamped to any arm or member of the brackets 24 or 28 (horizontal or vertical) as long as space exists for the trays, clips and brackets. Thus, FIG. 10 shows alternative attachment to upper arm 25 of C-shaped bracket 28 shown on FIG. 7.

It will also be appreciated that while the clip 36 and trays 12 attach to the top of the bracket member 23, the wires and clip could be attached to the bottom of the member 23 by inverting the connection.

In another alternative, clip 36 could be sized to engage transverse wires 20 rather than, or in addition to, main wires 16.

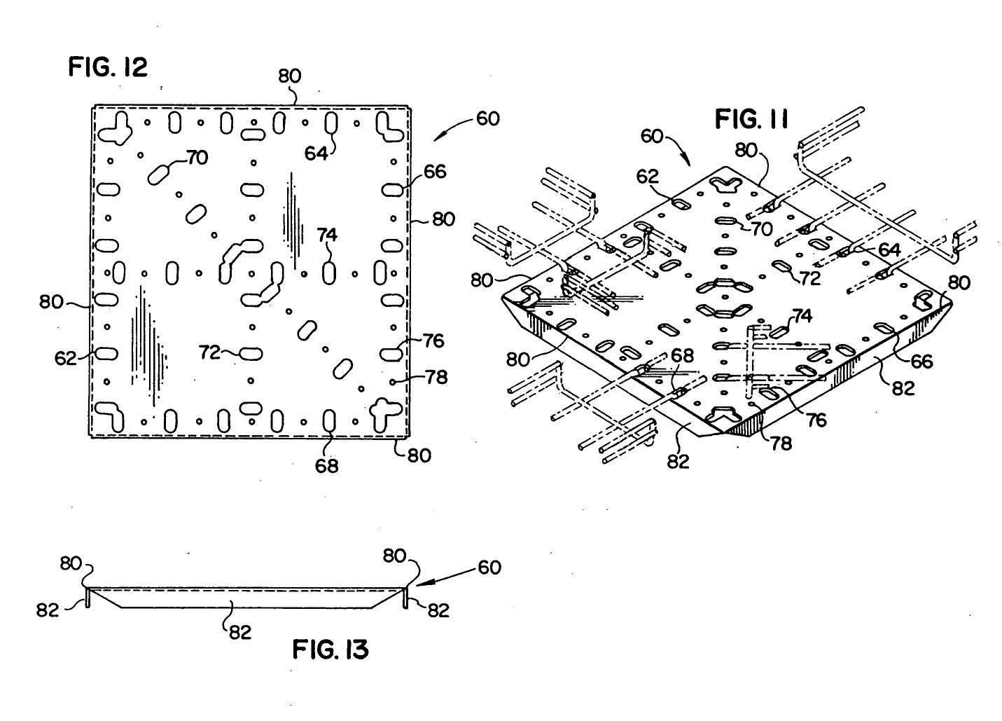

In another aspect of the invention, a solid junction plate, indicated in general at 60 in FIGS. 11-13, is provided for connecting to a number of support trays 12. Here, the junction plate 60 is square but could be a different shape. The junction plate 60 has multiple arrays 62-74 of elongated slots 76 for receiving hook ends 22 from support trays 12. An array of holes 78 is alternately spaced with each array of slots 62-74 to permit the clamp plate 36 and fastener 50 (shown in FIGS. 5-6 and 7-9) to secure the trays 12 to the junction plate 60.

The junction plate 60 has one array of slots 62-68 along each of its edges 80 as well as one array 70 diagonally across the center of the plate 60. Each edge 80 terminates in its own rim or lip 82. Another two arrays 72, 74 are positioned across the center of the plate 60 in a “+” pattern. This allows support trays 12 to extend off of the junction plate 60 in six different directions (off of each edge 80 and two ways from diagonal array 70). The arrays (62, 72, 66) and (64, 74, 68) allow for attachment at three different horizontal and vertical positions (e.g. left, center, right). Slots are used in the arrays so that two adjacent support trays 12 can be connected end-to-end at any single array of slots on the plate 60. This allows for a wide variety of configurations with one to four support trays 12 on the junction plate 60. Even more than four trays can be used when using small trays that cover less than an entire edge 80 (e.g. where the width of a support tray only covers half of edge 80).

While the preferred embodiments of the invention have been shown and described, it will be apparent to those skilled in the art that changes and modifications may be made therein without departing from the spirit of the invention, the scope of which is defined by the appended claims.

What is claimed is:

1. A cable support system comprising:
a support bracket with a generally horizontal, elongated member including at least one slot;
at least two adjacent support trays for supporting cables, each of said support trays having a wire with a bent hook end, said hook ends of the two adjacent support trays opposing each other and engaging said at least one slot of said elongated member; and
a fastening mechanism for securing both of said tray ends to said elongated member.

2. The system of claim 1, wherein the elongated member of the support bracket defines a longitudinal central axis and said at least one slot has a longest dimension that is perpendicular to said longitudinal central axis.

3. The system of claim 1, wherein longitudinal wires extend through both of said trays and cooperatively define a single straight line, said slot being sufficiently proportioned to maintain said longitudinal wires in said single straight line over said bracket.

4. The system of claim 3, wherein said single straight line and said longitudinal wires are generally perpendicular to a longitudinal central axis of said member.

5. The system of claim 1, wherein said bracket has a pair of horizontal arms so as to be C-shaped and said elongated member is one of said horizontal arms of said bracket.

6. The system of claim 1, wherein said bracket is L-shaped and said elongated member is a horizontal arm of said bracket.

7. The system of claim 1, wherein said bracket has at least two of said slots and each said support tray has at least two longitudinal wires with bent hook ends, and wherein said member defines an aperture separate from said slot, and wherein said fastening mechanism includes:
a clamp plate defining an aperture and disposed on said longitudinal wires, and
a threaded fastener placed through both said apertures and securing said longitudinal wires to said bracket.

8. The system of claim 1 wherein the support trays are constructed from steel wire.

9. A cable support system comprising:
a bracket with an elongated member, the elongated member having a longitudinal central axis and an array of slots generally along said central axis;
at least two adjacent support trays for supporting cables, each of said support trays having opposing ends featuring bent hook ends, said slots on said member receiving said hook ends from both said adjacent support trays; and
a fastening mechanism for fastening said hook ends of said adjacent trays to said bracket.

10. The system of claim 9, wherein said slots have a longest dimension that is perpendicular to the longitudinal central axis of the elongated member.

11. The system of claim 9, wherein said bracket has a pair of horizontal arms so as to be C-shaped and said elongated member is one of said horizontal arms of said bracket.

12. The system of claim 9, wherein said bracket is L-shaped and said elongated member is a horizontal arm of said bracket.

13. The system of claim 9, wherein said member includes an array of apertures that alternate with the array of slots, and wherein said fastening mechanism includes:
a clamp plate defining an aperture and disposed on said hook ends, and
a threaded fastener placed through both said apertures and securing said hook ends to said bracket.

14. The system of claim 9 wherein the supports trays are constructed of steel wire.

15. A cable guide system, comprising:
at least two support trays for guiding cables, each tray having at least one end with at least two wires having bent hook ends;
a plate defining multiple arrays of elongated slots for receiving said hook ends of said support trays, said slot arrays being arranged for selectively extending said support tray(s) in more than two different directions from said plate, wherein two said support trays can be connected end-to-end; and
a fastener mechanism for securing said support tray(s) to said plate.

16. The system of claim 15, including an array of apertures spaced alternately with each array of slots, said fastener mechanism including a clamping plate engaging at least two said wires, a threaded fastener extending through said clamping plate and engaging said solid plate.

17. The system of claim 15, wherein said solid plate has four sides and has said arrays of slots at least formed horizontally and vertically along each said side.

18. The system of claim 15, wherein said solid plate is quadrilateral and has at least two said arrays disposed diagonally generally forming an ‘X’ on said solid plate.

19. The system of claim 15, wherein said array of slots are arranged for selectively extending said support trays in any one of at least six different directions from said solid plate.

20. The system of claim 15 wherein the support trays are constructed from steel wire.
